(19) United States
(12) Patent Application Publication
(10) Pub. No.: US 2003/0130380 A1
(43) Pub. Date: Jul. 10, 2003

(54) Adhesive composition

(76) Inventors: Edmund W. Figiel, Ringoes, NJ (US); Michael A. Zolovick, Manville, NJ (US); John E. Orloff, Lawrenceville, NJ (US); Patrick B. Mwonya, Jamesburg, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/039,987

(22) Filed: Jan. 4, 2002

(51) Int. Cl. C08J 3/00

(52) U.S. Cl. 524/47

(57) ABSTRACT

Waterborne adhesives having improved drying properties are prepared using, for example cross-linked alkyl succinic anhydride.

### FIELD OF THE INVENTION

The invention relates to adhesive compositions, in particular waterborne adhesive compositions, that have improved drying speeds.

### BACKGROUND OF THE INVENTION

Liquid solvent-based adhesives, aqueous liquid adhesives and hot melt adhesives are conventionally used to bond one substrate to a second substrate. Each of these adhesives, however, have a number of disadvantages associated with their use. Solvent-based adhesives pose environmental and health hazards and are difficult to handle, as are hot melt adhesives. Aqueous liquid adhesives provide for environmentally friendly adhesives over alternative solvent base adhesives, and increased safety and handling versus hot melt adhesives, but require significant drying times.

Due to the water present in aqueous liquid adhesive formulations, also known as “waterborne,” “aqueous-based” or water-based” adhesives, such adhesives dry or cure more slowly than solvent borne and hot melt formulations. Long drying times required when using waterborne adhesives have limited their use in applications where increased bonding speed is desirable in adhesive bonding applications and where long set or cure is not economic or otherwise cost effective due to constraints in line speed, production, delays in packaging and storage, and the like.

To enable waterborne adhesives to be used in applications requiring increased bonding speed, and to make their use in packaging applications, e.g., bottle labeling, folding carton, corrugating, tube winding, tissue towel, bags, glued lap, and laminating, and in wood bonding applications more economically tolerable, waterborne adhesive formulations offering faster cure, i.e., improved set speed, are needed. The current invention addresses this need by providing a waterborne adhesive having improved set speed not previously achievable with traditional water-based technology.

### SUMMARY OF THE INVENTION

One aspect of the invention is directed to an adhesive comprising an organic anhydride component in an amount effective to improve the set speed of the adhesive. Preferred organic anhydrides for use in the practice of the invention are alkenyl succinic anhydrides, most preferably octenyl succinic anhydride (OSA) and dodecenyl succinic anhydride (DDSA). The adhesive preferably also contains a cross-linking agent. In one preferred embodiment, the organic anhydride component comprises a cross-linked carrier starch. In a particularly preferred embodiment, the adhesive is a polymer resin emulsion-based adhesive such as a polyvinyl alcohol stabilized ethylene vinyl acetate resin emulsion.

Another aspect of the invention is directed to a method of increasing the set speed of an adhesive comprising adding to the adhesive an organic anhydride component in an amount effective to improve the set speed of the adhesive.

Still another aspect of the invention is directed to article of manufacture comprising the adhesive described herein. Articles of manufacture encompassed by the invention include but are not limited to articles made of paper and articles made of wood.

Yet another aspect of the invention is directed to a method for bonding materials together which comprises applying the adhesive described herein to a first substrate, bringing a second substrate in contact with the adhesive composition applied to the first substrate, and subjecting the applied composition to conditions (e.g., ambient air, heat and/or pressure) which will allow the composition to form a set bond.

### DETAILED DESCRIPTION OF THE INVENTION

The disclosures of all references cited herein are incorporated in their entireties by reference.

It has now been discovered that the addition of an organic anhydride to an adhesive composition improves the drying speed of the adhesive formulation, especially when added to waterborne compositions.

The organic anhydride used in the practice of the invention may be an alkyl, alkenyl, aryl, aralkyl and/or aralkenyl succinic anhydride. Most preferred are alkenyl succinic anhydrides such as octenyl succinic anhydride (OSA), dodecenyl succinic anhydride (DDSA), hexadecenyl succinic anhydride and the like, as well as combinations thereof. While the use of OSA will hereinafter be referred to, it is to be understood that the invention is not to be limited thereto.

In the practice of the invention, OSA groups are attached to hydroxyl groups within the composition of the formulation. An appropriate cross-linker (e.g., aluminum sulfate, for OSA groups, or calcium chloride in DDSA groups) is then applied to tie up the hydrophilic groups and make them perform hydrophobically. This reaction serves to change the surface tension and cause the water molecules to disperse more rapidly, thus promoting improved drying rates.

The organic anhydride may be added to any conventional adhesive, and is preferable added to a conventional waterborne adhesive. Non-limiting examples include, natural polymer solutions, synthetic polymer solutions and synthetic polymer emulsions such as polyvinyl acetate homopolymer or copolymer emulsions (neat or formulated with other components), polyvinyl alcohol, dextrins, starches, acrylates and synthetic and natural rubber emulsions. Particularly preferred adhesives of the invention comprise a vinyl acetate copolymer such as ethylene vinyl acetate or propylene vinyl acetate or mixtures thereof. Ethylene vinyl acetate and propylene vinyl acetate copolymers are well known commercially available materials. Exemplary techniques for their preparation are described in, for example U.S. Pat. Nos. 2,200,429 and 2,396,785. The vinyl acetate copolymer typically will be alcohol or surfactant stabilized. Other conventional additives, including plasticizers, fillers, preservative/biocides or the like may also be added, with water added to total 100%.

In the practice of the invention, the OSA is reacted onto hydroxyl groups contained within a polyhydroxy-containing adhesive formulation and are then cross-linked. Any multivalent salt, preferably a di- or trivalent metal or transitional metal (e.g., aluminum, calcium, iron, titanium) salt may be used as a crosslinking agent.

Organic anhydrides may be added to the base polymer as is or may be added as part of a cross-linked organic anhydride-modified starch component, such as an OSA-modified corn cross-linked with Al₂(SO₄)₃, or a DDSA-modified corn cross-linked with CaCl₂. That is, the adhesive polymer may itself contain hydroxyl groups, as would be the case with a natural polymer-based adhesive (e.g., starch), or hydroxy groups may be added to the adhesive formulation by introduction of an hydroxy-containing agent, variously referred to in the art as a stabilizing agent, a colloidal protecting agent, a dispersing agent, an emulsifying agent or the like (e.g. an alcohol-, dextrin- or surfactant- stabilized ethylene vinyl acetate-based adhesive). Such agents include but are not limited to starch, dextrin, polyvinyl alcohols and surfactants.

A particularly preferred adhesive formulation comprises ethylene vinyl acetate containing polyvinyl alcohol colloidal groups. The polyvinyl alcohol for use in the invention will be at least partially hydrolyzed. By partially hydrolyzed means that the degree of hydrolysis will be at least 87% or greater, preferably 89% or greater. Preferably, the polyvinyl alcohol will be fully hydrolyzed, i.e., the degree of hydrolysis will be about 98.5% or greater. Polyvinyl alcohol is commercially available from Air Products, Celanese and Du Pont, among others.

This polyhydroxy-containing adhesive is reacted with OSA and then crosslinked with aluminum sulfate. This process offers faster set speeds that disperse water in the film forming stage, allowing for improved drying rates. Alternatively, OSA groups that have been reacted onto particulates, such as starch, and have been cross-linked, can be added to formulations to improve the drying rate. Polysaccarides including flours, starches and dextrins, including native, converted or derivatized forms thereof, may be used in the practice of the invention. The amount of OSA groups bound to the starch will typically be from about 1 to 10% and preferably from about 2 to 5% by weight, based on the weight of dry starch.

The preparation of hydrophobic starch derivative can be carried out by procedures known in the art. One such method is disclosed in U.S. Pat. No. 2,661,349, which describes hydrophobic starch derivatives such as starch alkyl or alkenyl succinates. The '349 patent describes an aqueous method in which such derivatives are prepared using a standard esterification reaction where the anhydride reagent and starch are suspended in water and mixed under alkaline conditions. Another method for preparing the hydrophobic starch derivatives is disclosed in U.S. Pat. No. 5,672,699. This patent describes a method for preparing hydrophobic starch derivatives having improved reaction efficiencies wherein the starch and anhydride reagent are predispersed or intimately contacted at low pH before being brought to alkaline reaction conditions. Other disclosures of the starch derivatives and the method of preparation can be found in “Starch: Chemistry and Technology”, second edition, edited by R. L. Whistler et al., 1988, pp. 341-343 and “Modified Starches: Properties and Uses”, edited by O. Wurzburg, 1986, Chapter 9, pp. 131-147.

Adhesive formulations will optionally contain conventional additives including but not limited to fillers including polysaccride fillers, plasticizers, acids, waxes, synthetic resins, tackifiers, defoamers, preservatives, dyes, pigments, UV indicators, and other additives commonly used in the art.

Preservatives for use herein include those conventionally used in aqueous adhesives such as benzoates, amides and fluorides such as sodium fluoride. Also included are the hydroxybenzoic acid esters such as p-hydroxybenzoic acid methyl ester or p-hydroxybenzoic butyl ester. Commercially available preservatives which may be used in the practice of the invention include KATHON LXE sold by Rohm & Haas Company and Nipacide OBS sold by Clariant. The preservative will generally be included in amounts of from 0.05% to about 0.2% by weight.

The invention provides adhesive compositions having increased set speed, and provides a method of increasing the set speed of an adhesive, in particular a waterborne adhesive, comprising adding to the adhesive an organic anhydride component in an amount effective to improve the set speed of the adhesive.

The adhesive formulations of the invention may be used to bond one substrate a second similar or different substrate and. Preferred are porous substrates including paper and wood. As used herein “paper” means both paper and paperboard products, both single- and multi-ply (e.g., paper laminates, corrugated boards) sheets made from without limitation, Kraft paper, paper made from recycled fibers and the like. The term “wood” is meant to include wood composites and particle board and encompass chipboard, particleboard, medium density fiberboard, high density fiberboard, oriented strandboard, hardboard, hardwood plywood, veneer core plywood, isocyanate or phenolic impregnated strawboard, and wood composites made from woodfiber and polymers, such as recycled polyethylene.

Substrates may be bonded together by a process wherein the adhesive composition is applied to at least a first substrate, a second substrate is brought in contact with the adhesive composition applied to the first substrate, and the applied adhesive is subjected to conditions which will allow the adhesive composition to form a set bond, such conditions including air, heat and/or pressure.

If desired, the adhesive may be applied in the foamed state. The adhesive composition of the invention may be foamed by the addition of energy by means known in the art such as, but not limited to, mechanical and/or chemical means. Air or other gases are added to the foamable adhesive composition along with the addition of said energy to produce a stable, consistent foamed adhesive. The adhesive foam may be produced by mechanical means such as mechanical stirring or agitation, introduction of gases or by chemical means.

The adhesive may be used to manufacture articles made of paper and/or wood. Such articles include without limitation bottle labeling, folding carton, corrugating, tube winding, tissue towel, bags, bag handles, glued lap, laminating, and in the manufactured of corrugated boards.

The invention can be illustrated by the following non-limiting examples.

### EXAMPLES

In the examples that follow, the reported set speed represents a subjective determination of fiber tear, as conducted by procedures well known and accepted in the art. In Examples 2 and 3, the observations of two different individuals are recorded.

### Example 1

An EVA emulsion containing PVOH colloid groups was treated with different amounts (from 1%-10% weight percent) of an Al₂(SO₄)₃ crosslinked corn starch carrier containing 3% OSA (DRY FLO, available from National Starch and Chemical Company) and allowed to mix for thirty minutes. This formulation was applied at room temperature to the wire side of an unbleached Kraft substrate using a 1-mil bird applicator. An untreated EVA resin (Sample 1A) was used as the control. Set speed was recorded. The results are shown in Table 1.

TABLE 1

| Sample | Set Speed (sec.) |
|---|---|
| Sample 1A (Control) | 11 |
| Sample 1B (1% DRY FLO) | 8 |
| Sample 1C (2% DRY FLO) | 8 |
| Sample 1D (3% DRY FLO) | 7 |
| Sample 1E (4% DRY FLO) | 6 |
| Sample 1F (5% DRY FLO) | 5 |
| Sample 1G (10% DRY FLO) | 4 |

### Example 2

An EVA emulsion containing PVOH colloid groups (control Sample 2A) was treated with 1% OSA (Samples 2C and 2E) or 3% OSA (Samples 2D and 2F). Samples 2E and 2F were also crosslinked with Al₂(SO₄)₃. All Samples were allowed to mix for thirty minutes. These formulations were applied at room temperature to the wire side of an unbleached Kraft substrate using a 1-mil bird applicator. An untreated EVA resin (Sample 2A) and EVA treated only with an amount of water equal in volume to the amount of OSA added (Sample 2B) were used as control samples. Set speed was recorded. The results are shown in Table 2.

TABLE 2

| Sample | Set speed (sec.) | Set speed (sec.) |
|---|---|---|
| Sample 2A (control) | 18-22 | 25-30 |
| Sample 2B (H₂O diluted) | 15-18 | 20-25 |
| Sample 2C (1% OSA) | 14-16 | 15-19 |
| Sample 2D (3% OSA) | 12-16 | 14-17 |
| Sample 2E (1% OSA + 0.5% Alum) | 10-12 | 10-15 |
| Sample 2F (3% OSA + 1.5% Alum) | 12-13 | 15-17 |

### Example 3

An EVA emulsion containing PVOH colloid groups was treated with differing amounts (1%, 3% or 5%) of DRY FLO (Al₂(SO₄)₃ crosslinked starch containing 3% OSA) (Samples 3B, 3C and 3D), different amounts (1% or 3%) of FILMKOTE 70, 54 or 550 (FILMKOTE 70, 54 and 550 are non-crosslinked corn starch that contain 3% OSA (FILMKOTE 54 and 70) and 6% OSA (FILMKOTE 550) and which are available from National Starch and Chemical Company (Samples 3E-3J), or differing amounts (1% or 5%) of corn starch containing 25% OSA (Samples 3K and 3L) and allowed to mix for thirty minutes. These formulations were applied at room temperature to the wire side of an unbleached Kraft substrate using a 1-mil bird applicator. An untreated EVA resin (Sample 3A) was used as the control. Set speed was recorded. The results are shown in Table 3.

TABLE 3

| | Set speed | Set speed | % |
|---|---|---|---|
| Sample | (sec.) | (sec.) | Fiber Tear |
| Sample 3A (control) | 10-12 | 15-20 | 65 |
| Sample 3B (1% DRY FLO) | 9-11 | 14-18 | 85 |
| Sample 3C (2% DRY FLO) | 5-7 | 10-14 | 95 |
| Sample 3D (5% DRY FLO) | 4-6 | 5-10 | 100 |
| Sample 3E (1% FILMKOTE 70) | 6-8 | 12-18 | 100 |
| Sample 3F (5% FILMKOTE 70) | 6-9 | 14-19 | 100 |
| Sample 3G (1% FILMKOTE 54) | 5-7 | 14-20 | 100 |
| Sample 3H (5% FILMKOTE 54) | 5-7 | 15-18 | 100 |
| Sample 3I (1% FILMKOTE 550) | 5-7 | 9-14 | 100 |
| Sample 3J (5% FILMKOTE 550) | 5-7 | 13-18 | 100 |
| Sample 3K (1% of 25% OSA Corn) | 6-8 | 10-14 | 100 |
| Sample 3L (5% of 25% OSA Corn) | 5-8 | 12-18 | 100 |

### Example 4

A formulated adhesive product comprising a polyvinyl alcohol and surfactant stabilized EVA resin and containing 5% of a plasticizer (Benzoflex 50) was used as the control adhesive (Sample 4A). Control adhesive Sample 4A is an example of a fast setting formulation (33-1557, available from National Starch and Chemical Company, Bridgewater, N.J.) that is representative of a high performing adhesive based on conventional technology. This formulation was treated with 1% OSA (Sample 4B), 2% OSA (Sample 4C) or 3% OSA (Sample 4D). To Sample 4D was added 1.5% Al₂(SO₄)₃ (Sample 4 E). All Samples were allowed to mix for thirty minutes. These formulations were applied at room temperature to the wire side of an unbleached Kraft substrate using a 1-mil bird applicator. Set speed was recorded. The results are shown in Table 4.

TABLE 4

| Sample | Set Speed (sec.) |
|---|---|
| Sample 4A (control) | 18, 20 |
| Sample 4B (1% OSA) | 15, 15 |
| Sample 4C (2% OSA) | 11, 10 |
| Sample 4D (3% OSA) | 8, 9 |
| Sample 4E (3% OSA + 1.5% Alum) | 7, 6 |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. An adhesive comprising an organic anhydride component in an amount effective to improve the set speed of the adhesive.

2. The adhesive of claim 1 wherein the organic anhydride component is an alkenyl succinic anhydride.

3. The adhesive of claim 2 wherein the alkenyl succinic anhydride is octenyl succinic anhydride.

4. The adhesive of claim 3 wherein the adhesive has been crosslinked.

5. The adhesive of claim 4 wherein the organic anhydride component comprises a crosslinked carrier starch containing octenyl succinic anhydride groups.

6. The adhesive of claim 3 comprising ethylene vinyl acetate.

7. The adhesive of claim 3 comprising starch.

8. The adhesive of claim 6 further comprising polyvinyl alcohol.

9. A method of increasing the set speed of an adhesive comprising adding to the adhesive an organic anhydride component in an amount effective to improve the set speed of the adhesive.

10. The method of claim 9 wherein the organic anhydride component is octenyl succinic anhydride.

11. The method of claim 10 further comprising adding a crosslinking agent.

12. The method of claim 10 wherein the organic anhydride component comprises a crosslinked carrier starch containing octenyl succinic anhydride groups.

13. An article of manufacture comprising the adhesive of claim 5.

14. An article of manufacture comprising the adhesive of claim 8.

15. A method for bonding materials together which comprises applying the adhesive composition of claim 1 to a first substrate, bringing a second substrate in contact with the adhesive composition applied to the first substrate, and subjecting the applied composition to conditions which will allow the composition to cool and form a set bond.
